(19) United States
(12) Patent Application Publication
(10) Pub. No.: US 2019/0172102 A1
(43) Pub. Date: Jun. 6, 2019

(54) FORMAT AND FONT BASED HEURISTIC EXTRACTION OF DATA STRUCTURES

(71) Applicant: Google LLC, Mountain View, CA (US)

(72) Inventors: Shumeet Baluja, Leesburg, VA (US); Henry A. Rowley, Sunnyvale, CA (US)

(73) Assignee: Google LLC, Mountain View, CA (US)

(21) Appl. No.: 16/266,927

(22) Filed: Feb. 4, 2019

Related U.S. Application Data
(63) Continuation of application No. 15/084,223, filed on Mar. 29, 2016.
Application No. 15/084,223 is a continuation of application No. 11/026,507, filed on Dec. 30, 2004, now abandoned.
Application No. 11/026,507 is a continuation-in-part of application No. 10/880,868, filed on Jun. 30, 2004, now abandoned.

(51) Int. Cl. G06Q 30/02; H04L 29/08

(52) U.S. Cl. CPC G06Q 30/0277; H04L 67/02; G06Q 30/0255; H04L 67/18; G06Q 30/02; G06Q 30/0246; G06Q 30/0269; G06Q 30/0251; G06Q 30/0267

(57) ABSTRACT

Font or format-based heuristic extraction of data structures are described. A data structure storage entity is accessed. A heuristic extraction technique comprising a font or format-based policy is used to parse the data structure and extract data from the data structure. Content selection criteria is determined from the data extracted from the data structure using the parsing technique. Online content items are generated with the determined content selection criteria. An online content item is selected responsive to location information received via a global positioning component of a computing device. The computing device receives, via a network, the selected online content item and is instructed to render the selected online content item.

### § 1. BACKGROUND

### § 1.1 Field of the Invention

The present invention concerns advertisements (“ads”), such as ads served in an online environment. In particular, the present invention concerns generating and serving location-relevant ads, such as ads for devices with call functionality, and/or a limited ability to render Web pages in a manner satisfying to a user (e.g., due to small displays, slow communications connection speeds, and/or slow rendering).

### § 1.2 Background Information

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword relevant advertising has been used by search engines, such as the Ad Words advertising system by Google of Mountain View, Calif. Similarly, content-relevant advertising systems have been proposed. For example, U.S. patent application Ser. No. 10/314,427 (incorporated herein by reference and referred to as “the '427 application”) titled “METHODS AND APPARATUS FOR SERVING RELEVANT ADVERTISEMENTS”, filed on Dec. 6, 2002 and listing Jeffrey A. Dean, Georges R. Harik and Paul Bucheit as inventors, and Ser. No. 10/375,900 (incorporated by reference and referred to as “the '900 application”) titled “SERVING ADVERTISEMENTS BASED ON CONTENT,” filed on Feb. 26, 2003 and listing Darrell Anderson, Paul Bucheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. The AdSense system by Google is an example of a content-relevant advertising system.

Unfortunately for online ad delivery businesses, it has been challenging to get local establishments to advertise online. The present inventors believe that local establishments may be reluctant to advertise online for at least three (3) main reasons. First, local establishments might not want to devote resources to yet another advertising channel. Second, local establishments might not be interested in developing an online presence. Even if they are interested, they might not have the skills to develop an online presence. Third, people often want to talk with someone at a local establishment (e.g., to order a pizza, make a reservation at a local restaurant, get a plumber, arrange for car-towing, get a cost estimate, make an appointment, etc.). In general, although searching the World Wide Web (simply referred to as “the Web” below) with a personal computer is often very useful for learning about businesses, and although some Websites facilitate communications (e.g., email) with an establishment, the Web is often not the ideal medium for users to communicate with local establishments.

Some mobile phone service providers have offered 411 services and concierge services. For example using a concierge service provided by Sprint, a user can ask an operator for a plumber in Palo Alto, and the operator finds the requested information for the user. Unfortunately, from the user's perspective, there may be fees associated with such services. From the service provider's perspective, ensuring helpful and courteous service may require recruiting, training, and retaining high-quality employees.

In view of these perceived shortcomings of online advertising by local establishments, it would be useful to improve advertising, such as online advertising for example, so that it meets the needs of local establishments and users. It would be preferable to avoid the need and expense of recruiting, training and retaining helpful and courteous employees.

### § 2. SUMMARY

Embodiments consistent with the present invention may be used to create ads that are relevant for local search (e.g., on desktop devices, mobile devices, etc.). These ads will be especially relevant for wireless devices, where queries for services that satisfy immediate needs are more likely to be initiated. Such embodiments may (a) obtain sets of information about local establishments, each set including at least one of business address information and a telephone number, (b) determine, for each of the sets, a location using at least one of at least a portion of the business address and at least a portion of the telephone number, and (c) generate, for each of the sets, generating an ad that includes targeting information that targets the serving of the ad to queries related to the determined location.

At least some embodiments consistent with the present invention may further accept a query including information about a location of a client device, and determine at least one of the generated ads that includes targeting information that targets the location of the client device.

In at least some embodiment consistent with the present invention, the information about a location of the client device included in the query includes a latitude and a longitude of the client device, is derived from a global positioning satellite derived position of the client device, includes an area code of a telephone number of the client device, or is derived from an access point with which the client device is registered.

In at least some embodiments consistent with the present invention, the sets of information about local establishments may be accepted from a data feed including information about Yellow Pages listings.

A Yellow Page listings publisher, and/or a local establishment, may be charged for serving ads over a given term (e.g., a year), or per ad impression, selection, and/or conversion.

### § 3. BRIEF DESCRIPTION OF THE DRAWINGS

FIG. 1 is a high-level diagram showing parties or entities that can interact with an advertising system.

FIG. 2 is a diagram illustrating an environment in which, or with which, the present invention may operate.

FIG. 3 is a Venn diagram illustrating a classification of user devices consistent with the present invention.

FIG. 4 is a flow diagram of an exemplary method for generating local ad information in a manner consistent with the present invention.

FIGS. 5 and 6 are diagrams of a mobile telephone with which with the present invention may be used.

FIG. 7 illustrates an exemplary data structure for storing an ad request message in a manner consistent with the present invention.

FIG. 8 is a flow diagram of an exemplary method for performing ad serve operations in a manner consistent with the present invention.

FIGS. 9-13 are exemplary ad displays consistent with the present invention.

FIG. 14 is a flow diagram of an exemplary method for performing user ad selection operations in a manner consistent with the present invention.

FIG. 15 is a block diagram of an exemplary apparatus that may perform various operations and store various information in a manner consistent with the present invention.

### § 4. DETAILED DESCRIPTION

The present invention may involve novel methods, apparatus, message formats, and/or data structures for generating and/or serving local online ads. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention as any patentable subject matter described.

In the following, environments in which, or with which, embodiments consistent with the present invention may operate are described in § 4.1. Then, exemplary embodiments consistent with the present invention are described in § 4.2. Examples of operations are provided in § 4.3. Finally, some conclusions regarding the present invention are set forth in § 4.4.

### § 4.1 Environments in which, or with which, Embodiments Consistent with the Present Invention May Operate

### § 4.1.1 Exemplary Advertising Environment

FIG. 1 is a high level diagram of an advertising environment. The environment may include an ad entry, maintenance and delivery system (simply referred to as an ad server) 120. Advertisers 110 may directly, or indirectly, enter, maintain, and track ad information in the system 120. The ads may be in the form of graphical ads such as so-called banner ads, text only ads, image ads, audio ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. An entity other than an ad consumer 130 may initiate a request for ads. Although not shown, other entities may provide usage information (e.g., whether or not a conversion or click-through related to the ad occurred) to the system 120. This usage information may include measured or observed user behavior related to ads that have been served.

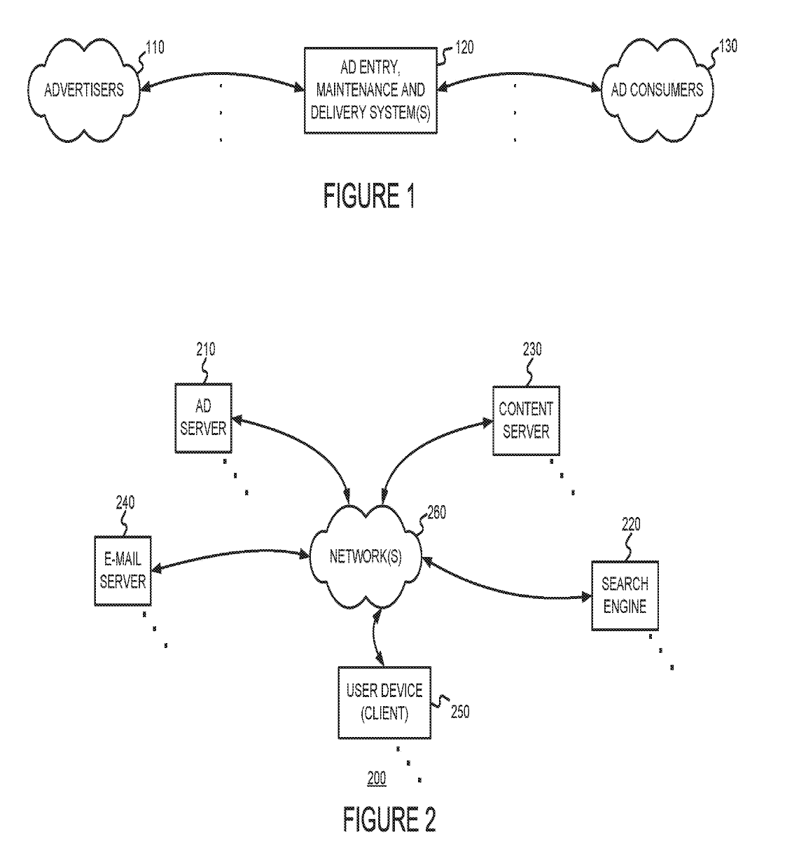

The ad server 120 may be similar to the one described in FIG. 2 of the '900 application. An advertising program may include information concerning accounts, campaigns, creatives, targeting, etc. The term “account” relates to information for a given advertiser (e.g., a unique e-mail address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, geolocation information, user profile information, user device characteristics, etc.), and price or offer information (e.g., maximum cost or cost per selection, maximum cost or cost per conversion, etc.)). Alternatively, or in addition, each ad group may include an average cost (e.g., average cost per selection, average cost per conversion, etc.). Therefore, a single maximum cost and/or a single average cost may be associated with one or more keywords, and/or topics. As stated, each ad group may have one or more ads or “creatives” (That is, ad content that is ultimately rendered to an end user.). Each ad may also include a link to a URL (e.g., a landing Web page, such as the home page of an advertiser, or a Web page associated with a particular product or server) and/or a telephone number. Naturally, the ad information may include more or less information, and may be organized in a number of different ways.

FIG. 2 illustrates an environment 200 in which the present invention may be used. A user device (also referred to as a “client” or “client device”) 250 may include a browser facility (such as the Explorer and pocket-PC Explorer browsers from Microsoft, the Opera Web Browser from Opera Software of Norway, the Navigator browser from AOL/Time Warner, the Firefox browser from Mozilla, etc.), an e-mail facility (e.g., Outlook from Microsoft), etc. A search engine 220 may permit user devices 250 to search collections of documents (e.g., Web pages). A content server 210 may permit user devices 250 to access documents. An e-mail server (such as Hotmail from Microsoft Network, Yahoo Mail, etc.) 240 may be used to provide e-mail functionality to user devices 250. An ad server 210 may be used to serve ads to user devices 250. The ads may be served in association with search results provided by the search engine 220. However, content-relevant ads may be served in association with content provided by the content server 230, and/or e-mail supported by the e-mail server 240 and/or user device e-mail facilities. Ads may be served by themselves, without other content from other servers.

As discussed in the '900 application (introduced above), ads may be targeted to documents served by content servers. Thus, one example of an ad consumer 130 is a general content server 230 that receives requests for documents (e.g., articles, discussion threads, music, video, graphics, search results, Web page listings, etc.), and retrieves the requested document in response to, or otherwise services, the request. The content server may submit a request for ads to the ad server 120/210. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, document information, user device characteristics, etc. The request may also include end user device characteristics.

The content server 230 may combine the requested document with one or more of the advertisements provided by the ad server 120/210. This combined information including the document content and advertisement(s) is then forwarded towards the end user device 250 that requested the document, for presentation to the user. Finally, the content server 230 may transmit information about the ads and how, when, and/or where the ads are to be rendered (e.g., position, selection or not, impression time, impression date, size, conversion or not, end user device characteristics, etc.) back to the ad server 120/210. Alternatively, or in addition, such information may be provided back to the ad server 120/210 by some other means.

Another example of an ad consumer 130 is the search engine 220. A search engine 220 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 220 may submit a request for ads to the ad server 120/210. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate, and/or as described below, information related to, and/or derived from, the search query), user device characteristics, and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc. The request may also include end user device characteristics.

The search engine 220 may combine the search results with one or more of the advertisements provided by the ad server 120/210. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

Finally, the search engine 220 may transmit information about the ad and when, where, and/or how the ad was to be rendered (e.g., position, selection or not, impression time, impression date, size, conversion or not, end user device characteristics, etc.) back to the ad server 120/210. As described below, such information may include information for determining on what basis the ad was determined relevant (e.g., strict or relaxed match, or exact, phrase, or broad match, etc.) Alternatively, or in addition, such information may be provided back to the ad server 120/210 by some other means.

The e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as an ad consumer 130. Thus, e-mails may be thought of as documents, and targeted ads may be served in association with such documents. For example, one or more ads may be served in, under, over, or otherwise in association with an e-mail.

Finally, the client device 250 may itself submit a request for ads to the ad server 210. In this case, the client device 250 may be thought of as an ad consumer.

Although the foregoing examples described servers as (i) requesting ads, and (ii) combining them with content, one or both of these operations may be performed by a client device (such as an end user computer for example).

### § 4.1.1 Definitions

Online ads may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, user device characteristics, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document being served includes certain topics or concepts, or falls under a particular cluster or clusters, or some other classification or classifications. In some systems, an advertiser may specify that its ad is to be served only to (or is not to be served to) user devices having certain characteristics. Finally, in some systems an ad might be targeted so that it is served in response to a request sourced from a particular location, or in response to a request concerning a particular location.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered) is referred to as the “conversion rate.” If a conversion is defined to be able to occur within a predetermined time since the serving of an ad, one possible definition of the conversion rate might only consider ads that have been served more than the predetermined time in the past.

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has an addressable storage location and can therefore be uniquely identified by this addressable location. A universal resource locator (URL) is an address used to access information on the Internet.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, Firefox, etc.), a media player (e.g., an MP3 player, a Realnetworks streaming audio file player, etc.), a viewer (e.g., an Abobe Acrobat pdf reader), etc.

A “content owner” is a person or entity that has some property right in the content of a document. A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

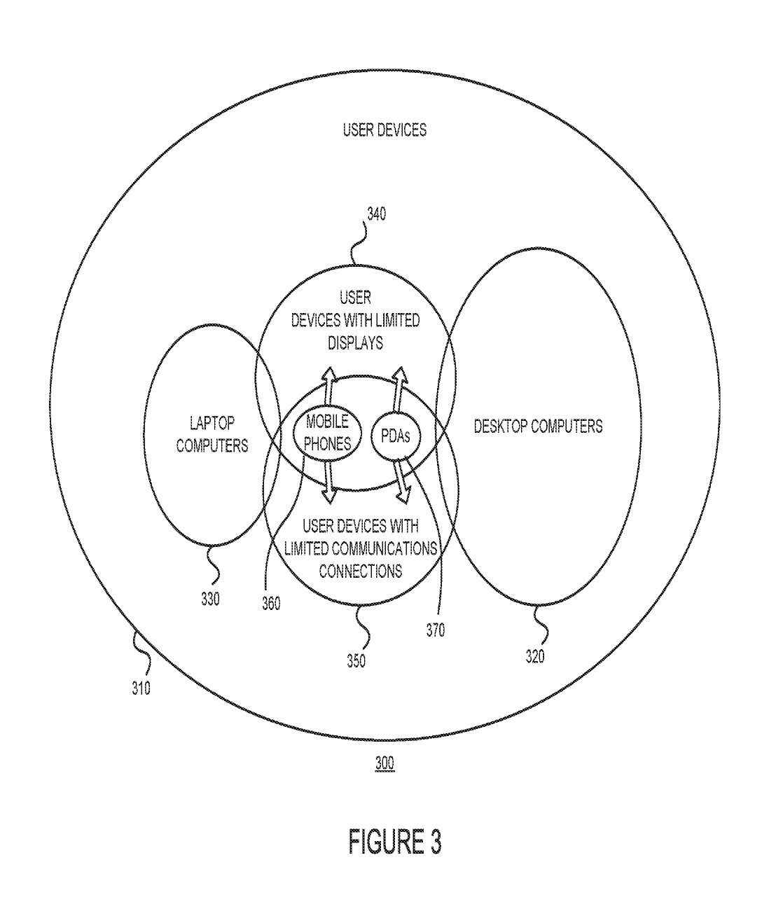

FIG. 3 is a Venn diagram illustrating a classification of user devices 300 consistent with the present invention. Some user devices 340 may have limited displays. Some user devices 350 may have limited communications connections. Most laptop computers 330 will not have limited displays or communications connections, but some may have limited displays and/or limited communications connections. Similarly, most desktop computers 320 will not have limited displays or communications connections, but some may have limited displays and/or limited communications connections. As shown, most present mobile telephones 360 and personal digital assistants (PDAs) 370 have limited displays and limited communications connections. However, as indicated by the arrows, displays and/or communications connections of such devices may improve. Similarly, other devices (not shown), such as handheld and/or wireless devices may have limited displays and/or limited communications connections.

A limited or small display may be thought of as one that cannot render Web pages in a manner satisfying to most users, or a target set of users, due to size, and/or resolution. A 3″ diagonal display common on most current generation PDAs is one example of a limited display in the context of most Web pages authored for personal computers. A 1.5″ diagonal display common on most mobile telephones is another example of a limited display in the context of most Web pages authored for personal computers. Similarly, a slow communications connection speed may be thought of as one that is too slow to permit loading Web pages in a manner satisfying to most users, or a target set of users. A 9.3 Kbps modem is one example of a slow connection speed in the context of loading most Web pages authored for personal computers. Similarly, a slow processor may be thought of as one that is too slow to permit a loaded Web page to be rendered in a manner satisfying to most users, or a target set of users. Finally, a limited user device may be thought of as one that cannot render requested Web pages in a manner satisfying to most users, or a target set of users (e.g., due to some combination of screen size, communications connection speed, and/or processor speed). What constitutes a limited user device, a limited display, a slow connection speed, and/or a slow processor may be defined by an advertiser, an ad serving system, an end user, or some combination of definitions from these parties and entities.

A “location” may be an exact position (e.g., a latitude and longitude), a geographic area (e.g., within a town, state, province, country, zip code, area code, district, on a body of water, etc.), a determinable area (e.g., in a building, building complex, etc.), etc.

“Device information” about a client device or an end user device may include information about whether or not the device has call functionality, a home-base area code of the device, an area code of a present location of the device, an access point with which a mobile device is (currently) registered, qualitative and/or quantitative information about processor speed, display size, display resolution, communications speed, etc. of the device, etc.

Although the present invention may be used with any user device having telephone call functionality, it is especially advantageous for use with user devices having telephone call functionality but having small displays, slow communications connections, and/or slow processors.

### § 4.2 Exemplary Embodiments

Exemplary embodiments for generating ads for local establishments, serving such ads, and processing responses to such ads are described in the following sections.

### § 4.2.1 Generating Ads for Local Establishments

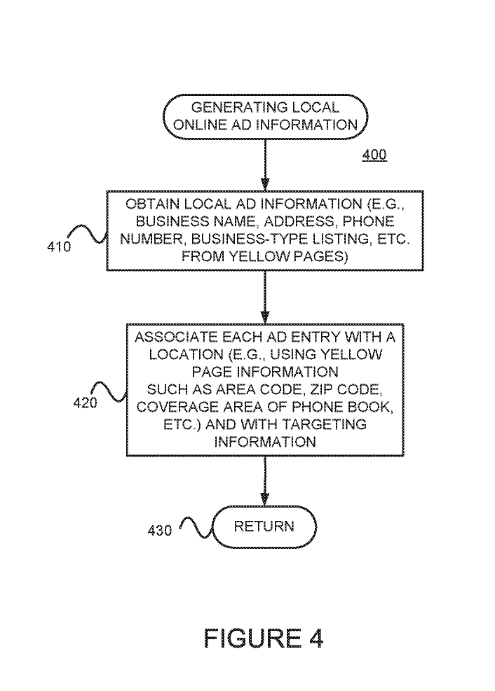

FIG. 4 is a flow diagram of an exemplary method 400 for generating local online ad information in a manner consistent with the present invention. This method 400 may be used to generate local online ads from Yellow Page information for example. Such local online ad information is needed before local requests can be served. The method 400 may obtain local ad information (Block 410) and associate each ad entry with location information and with targeting information (Block 420), before the method 400 is left (Node 430).

Referring to block 410, Yellow Pages information may be a source of data for online ads for local establishments. This information can be delivered in many forms. One form is as a data feed that has one or more, but preferably all, of the following fields:
business name;
address;
phone number; and
business-type listing (e.g., is it listed under “plumbers” or “painters” or “restaurant”, etc.).
   One or more additional fields such as graphics (e.g., logos, etc.), business hours, associated descriptive text, payment methods (e.g., VISA, MasterCard, American Express, Bank Check, etc.), etc. may also be provided.

Referring to block 420, in addition to gathering the field(s) listed above, each entry may also be associated with a location to which it applies. This location information may be, or may be derived from, the available fields described above, such as the area code of the phone number of the establishment, the zip code of the address of the establishment, the general coverage area of the phone book (e.g., Queens, N.Y. phonebook), etc. Targeting information (e.g., targeting keywords) may be derived from the Yellow Page listing information, such as business type, business name, ad text, etc.

If Yellow Pages information is received as a data file, then processing can begin immediately. If this information is not available as a data file, Yellow Pages books can be scanned with document scanners and techniques such as optical character recognition (OCR) may be used to fill in as many fields as possible. Most of the fields listed above will be easy to fill given the fairly consistent formatting of phone books. For example, sample heuristics to parse the information fields within an ad may include one or more of the following:
business name appears bold;
address appears next;
phone number is listed in a specific format ###-###-####;
type of business is listed in larger font format within a column;
type of business is listed in the page header;
images and logos can be scanned in and kept as graphics—and associated with the entry;
business hours may or may not get filled in, depending on whether they are listed in the yellow page listing (in some embodiments they are not present by default);
descriptive text can be read in via performing OCR on the advertisement that a company may have placed in the Yellow Pages;
payment methods can either be recognized via OCR, or because there are only a limited number of them (VISA, MASTERCARD, etc.) they will be recognizable just from their images by using simple image processing techniques, such as template matching. These heuristics are just examples of the types of rules that can be created to automatically parse scanned Yellow Pages into the correct data fields.

Once the data is gathered, online ads for local establishments can be generated from it. For simplicity, the business-type listing and associated descriptive text etc. can be used as the “keywords” which are used specify what an ad pertains to. Techniques described in U.S. patent application Ser. No. 10/674,056 (incorporated herein by reference and referred to as “the '056 application”), titled “GENERATING INFORMATION FOR ONLINE ADVERTISEMENTS FROM INTERNET DATA AND TRADITIONAL MEDIA DATA,” filed on Sep. 29, 2003 and listing Georges Harik as the inventor, may be used instead of, or in combination with, any of the techniques described in the present application.

In many online ad systems, one or more ads are displayed in association with a document, such as a search results page, or a Webpage with content for example. Typically, online ads include embedded information (e.g., links) such that when the ad is selected (e.g., by a user clicking on the ad), a browser is loaded with a document (e.g., a Webpage) associated with the ad. Such a document is commonly referred to as the “landing page” of the ad.

Although using Web pages, such as those authored in HTML or some other markup language for example, as ad landing pages is useful when the user is using a browser on a device with an adequate display monitor (e.g., 13″, 15″, 17″, 19″, 21″, etc., or perhaps even smaller), the use of the same Web pages as ad landing pages is much less useful when the user is using a device with a smaller and/or lower resolution display. Similarly, although using Web pages as ad landing pages is useful when the user device has an adequate communications connection to the Internet (e.g., a 56 Kbps modem, a higher speed digital subscriber line (DSL) modem, or a higher speed cable modem) and an adequate processor for rendering the Web page, using Web pages as ad landing pages is much less useful when the user device has a slow communications connection (e.g., 9.6 Kbps) and/or a slow processor. As can be appreciated from the foregoing, ads that are to be rendered on mobile phones should be concise and fast to download.

### § 4.2.2 Mobile Client Devices

As discussed above, rendering a linked landing Web page upon ad selection in accordance with standard clickthrough model might not be advisable for devices with limited displays and/or limited communications connections, such as wireless browsers. For example, the advertiser's linked Website or Web page might not look good, and indeed might not even function, on a wireless telephone with rendering capabilities. In such a case, rendering or trying to render an ad landing page when an ad is selected may be harmful and make the advertiser look bad. As another example, making a connection and downloading another Web page may be quite slow for devices with limited communications connections. For example, Sprint's wireless network has been only 9.6K baud. Making the user incur another delay before getting a potentially mediocre experience might not be advisable. Further, on devices with limited displays, it is more difficult, perceptually, to keep track of one's state; making the user look at an intermediate text page will only serve to exacerbate this difficulty. Even if the advertiser's landing Web page and Website function well on a device with a limited display and/or communications connection, such as a mobile telephone, the chances of a conversion (e.g., a transaction being consummated) may remain quite small due to input limitations of mobile telephones. For example, entering shipping information and credit card information with a mobile telephone keyboard may be slow and frustrating. Finally, even if the user device is not limited in terms of rendering a selected Web page, it may nonetheless be advantageous to provide an ad with call-on-select functionality since such ads may have a higher conversion rate than ads in which a landing Web page is loaded in response to a selection.

The present invention may be used to (i) provide user device information (such as whether or not the user device has a slow display, a slow communication connection, a slow processor, a limited user input, and/or call functionality) in an ad request, (ii) select and/or score ads using user device information and user device location, (iii) display or otherwise render ads with a call-on-select feature, and/or (iv) initiate a call responsive to a call selection. The present invention may do so using various techniques, described below. As will be appreciated by those skilled in the art, at least some of these techniques may be used alone, or in combination.

Some of the exemplary embodiments are described below with respect to a mobile telephone. In some of the exemplary embodiments described below, a call-on-select “button”, such as a telephone icon for example, is displayed with (e.g., within, adjacent to, etc.) an advertisement. The call-on-select button indicates that if the user clicks the button (or perhaps other portions of the ad), a call will be generated from the mobile telephone. These exemplary embodiments have a number of advantages. If the user is using a mobile telephone, the user may not want to interact via the small screen. However, the user can be connected with the advertiser by voice. If a button or hyperlink is used to initiate a telephone call, the user does not need to write down or try to remember a telephone number. Orders can be placed without requiring the user to scroll through various information and enter information using often limited keypads. Finally, advertisers are directly connected with advertisers, which is often desirable particularly in the context of local establishments.

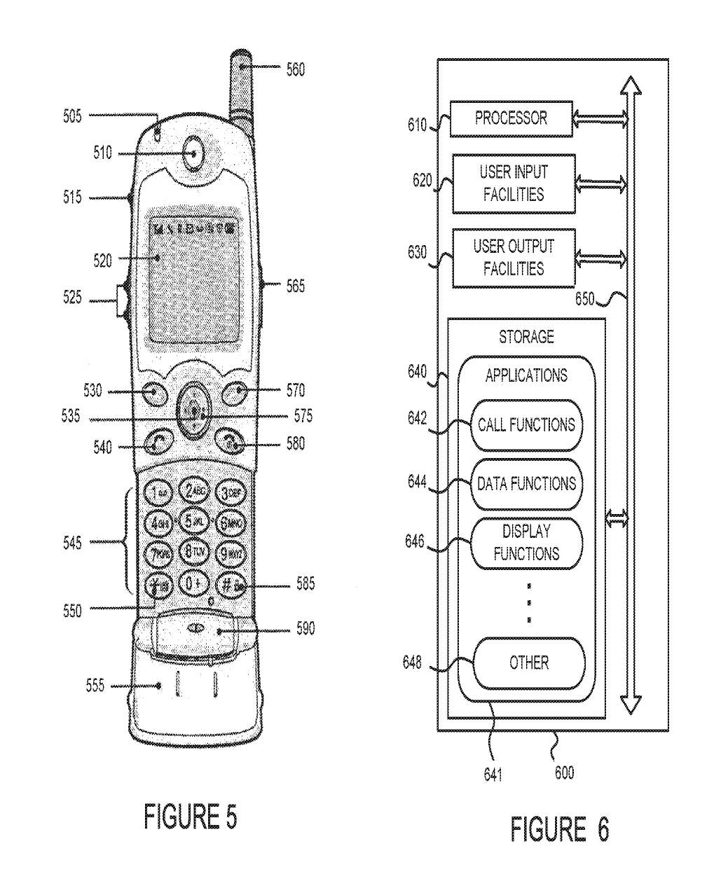

FIGS. 5 and 6 are diagrams of mobile telephones with which with the present invention may be used. The mobile telephone 500 of FIG. 5 may include one or more of a call indicator 505, an earpiece 510, a record key 515, a display screen 520, an up/down side key 525, a soft left key 530, an easy key 535, a send key 540, numeric keys 545, a star key 550, an active flip 555, an antenna 560, a hands-free connector 565, a soft right key 570, navigation keys 575, an end/power key 580, a hash or pound key 585 and a microphone 590.

FIG. 6 is a block diagram of a mobile telephone 600 with which the present invention may be used. The mobile telephone 600 may include one or more processors 610, one or more user input facilities 620 (e.g., keys and microphone), one or more user output facilities 630 (e.g., display and speaker) and one or more storage facilities 640. These facilities can communicate with one another via one or more buses or networks 650. The storage facilities 640 may include various applications 641, such as applications that support call functions 642, applications that support data functions 644, applications that support display functions 646, as well as additional applications 648. The data functions 644 may include browser functions. Finally application program interfaces (APIs) may be provided which allow data functions 644 to access call functions 642.

Currently, some telephones can extract telephone number information from short-message-service (SMS) messages (e.g., by looking for simple patterns ###-###-####, (###) ###-####, etc.). Therefore, an ad delivered in SMS can include a telephone number that will be recognized—and if selected can cause the telephone to dial the telephone number. Microsoft has already installed a feature in its pocket-PC Explorer which uses the following syntax:
<a href=“tel:12063722651”>call me</a>
   which basically puts up a link that, if pressed, calls the telephone number in the “tel:” tag.

Most phones that support data and voice modes usually include a limited amount of interaction between the data and voice sides. However, dialing from a Web page is possible by having an application on the user device use APIs, available on many mobile telephones, to dial a telephone number that is often exposed to the data side. The mobile client applications may be developed using various commercially available platforms such as Binary Runtime Environment for Wireless ((BREW) from Qualcomm of San Diego, Calif.), Java 2 Micro Edition ((J2ME) from Sun of Santa Clara, Calif.), Symbian, Smartphone, etc., for example. BREW and J2ME allow commands, such as initiative voice-call, to be sent to applications for the voice functions of the telephone.

### § 4.2.3 Ad Request

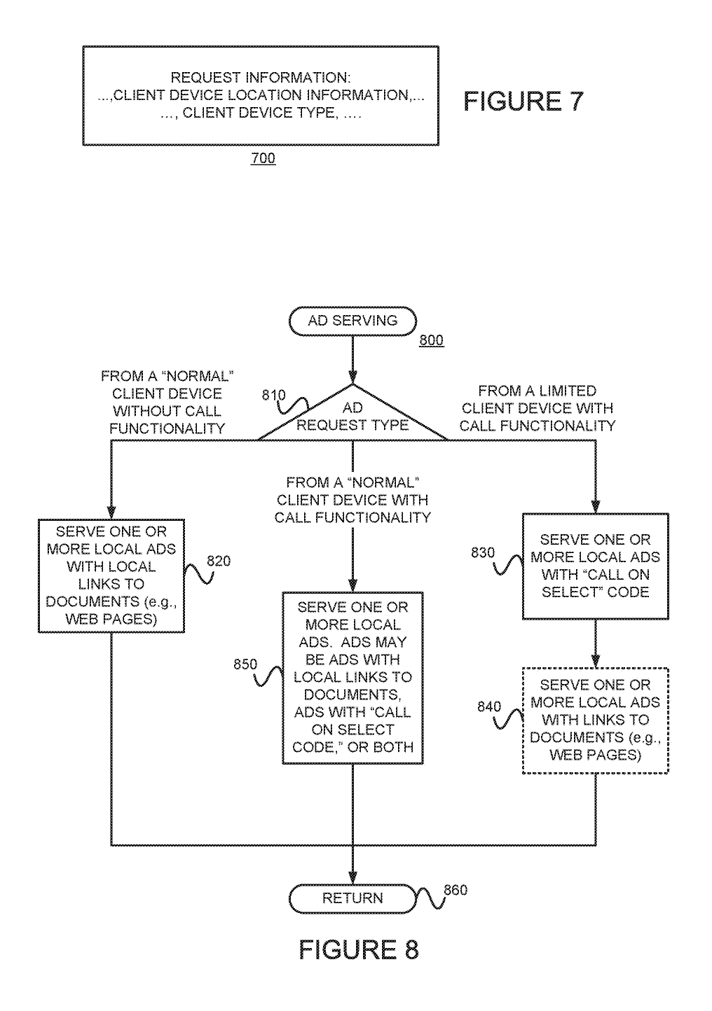

FIG. 7 illustrates an exemplary data structure 700 that is consistent with the present invention, for storing an ad request message. Among other things, such as information used for targeting relevant ads for example, the message 700 may include client device type information as well as client device geolocation information 700. Such client device type information may be used to determine one or more of (i) whether or not the user device has a small display, and/or a size of the display, (ii) whether or not the user device has a low resolution display, and/or the resolution of the display, (iii) whether or not the user device has a limited communications connection, and/or a speed of the connection (which may instead be inferred), (iv) whether or not the user device has a slow processor, and/or the speed of the processor, (v) whether or not the user device is limited in terms of loading and rendering a Web page, (vi) whether or not the user device has call functionality, (vii) whether or not the user device has supports various authoring languages (e.g., a HTML, SGML, XML, WAP, WAP 2.0, dHTML, xHTML, Java, Javascript, etc.), (viii) whether the user device is supporting a currently active (not terminated) telephone call, (ix) whether or not the user device has a limited user input, (x) what type of user input is provided (e.g., touch screen, stylus, limited keypad, full keyboard, pointers, etc.), etc. Such user device information may be used in a determination of whether or not to serve certain ads or certain types of ads, and/or how to score competing ads.

Client device “geolocation information” may include information specifying one or more of one or more countries, one or more (inter-country) regions, one or more states, one or more metro areas, one or more cities, one or more towns, one or more boroughs, one or more areas with common zip codes, one or more areas with common telephone area codes, one or more areas served by common cable head end stations, one or more areas served by common network access points or nodes, etc. It may include latitude and/or longitude, or a range thereof. It may include information, such as an IP address, from which a user location can be estimated.

Further, the ad request information may include end user (or some other entity, simply referred to as “end user” in the specification) geolocation information, or information from which end user geolocation can be derived or estimated. For example, the end user geolocation information may include one or more of a country, a region (e.g., pacific coast, north-east, mid-Atlantic, south-west, etc.), a state, a metro area (e.g., San Francisco Bay Area, Metro District of Columbia Area, etc.), a city, a town, a postal zip code, a telephone area code, etc.

The geolocation information may be encoded in various ways. For example, a country identifier may be a two character code such as those determined by the International Organization for Standardization (“ISO”). The region identifier may be a six character code such as those determined by UTF8. Thus, the country and region can be encoded using the ISO 3166-2/1999 standard which is a two letter country code followed by a “-” and 1-3 alphanumeric characters. The ISO 3166-2/1999 standard code can be mapped to a numerical identifier (e.g., in the range of 20001-30000). New regions can be assigned a numerical identifier appended to the end. In one embodiment of the present invention, more than 200 countries and 1300 regions are uniquely identified. The metro area identifier may be based on the DMA standard. In one embodiment, metro areas can cross state lines. Accordingly, in such an embodiment, a metro area is not necessarily “contained” within a state. Since the same city or town name can be used for different cities or towns in different states, such information should be used in combination with state information to avoid ambiguity. Postal zip codes can be encoded as a 5-digit integer, or extended with 4 or more digits. Telephone area codes may be encoded as a three-digit integer. Other ways of encoding geolocation information are possible.

The present invention may be used to derive or estimate geolocation information from other information. For example, if the client device is a mobile telephone with GPS functionality, the client device geolocation may be provided by components in the mobile telephone that provide GPS functionality. As another example, the present invention may use known techniques (such as that used by the “NetAcuity” product from Digital Envoy of Norcross, Ga.) to map Internet protocol (“IP”) address and/or domain information to geolocation information. As another example, Internet service providers may have many dial-in access servers, each associated with a telephone area code. As yet another example, an end user's location might be inferred from a regional term (e.g., hoagie, hero, grinder, sub) entered by the user. If multiple factors are used to infer geolocation, but lead to inconsistent locations, each without a desired level of confidence, a more general, consistent location, can be used. Alternatively, the present invention may simply accept previously derived or provided geolocation information. For example, the end user, or a client device used by the end user, may have voluntarily provided geolocation information. As another example, the geolocation information may have been derived and provided by a third party.

Although some examples above used geolocation information as a current location of the user, the geolocation information may be a location that the user is interested in.

Other ways of communication or inferring user device type may be used and the present invention is not limited to the foregoing message data structure, nor is it limited to the types of information listed.

### § 4.2.4 Selection and/or Scoring of Ads

FIG. 8 is a flow diagram of an exemplary method 800 for performing ad serving operations in a manner consistent with the present invention. As indicated by block 810, different branches of the method 800 may be performed depending on an ad request type. If the ad request type is (sourced) from a “normal” client device without call functionality, one or more local ads with links to documents (e.g., Web pages) are served (Block 820) before the method 800 is left (Node 860). Examples of such ads include keyword-targeted text ads. The ads may be served in accordance with an ad score. The score of an ad may be a function of one or more of (i) its relevance to a current user interest (e.g., inferred from a search query or document), (ii) relevance to a user type, (iii) relevance to a user, (iv) an offer per impression, (v) an offer per user action (e.g., selection, conversion, etc.), (vi) a performance parameter of the ad (e.g., selection rate, user rating, conversion rate, etc.), (vii) location targeting information, etc. A “normal” client device that is one that is not a “limited” client device. For example, a normal client device may be one with a normal display and/or a normal connection speed such as a personal computer for example.

Referring back to block 810, if the ad request type is (sourced) from a “normal” client device with call functionality, one or more local ads can be served. The local ad(s) may be ad(s) with links to documents, ad(s) with “call on select” code, or both. (Block 850) Thus, one or more local ads with “call-on-select” code may be served, or at least compete for serving. For example, even if a user device can load and render a Web page in a way satisfactory to most users, or a group of target users, it may be advantageous to serve call-on-select ads since such ads may have a higher conversion rate, and/or may be expected to generate more revenue for the advertiser. This higher conversion rate may be reflected in the score of the ads. As was the case with block 820 of the left branch, the ads may be served in accordance with an ad score. The score of an ad may be a function of one or more of (i) its relevance to a current user interest (e.g., inferred from a search query or document), (ii) relevance to a user type, (iii) relevance to a user, (iv) an offer per impression, (v) an offer per user action (e.g., selection, conversion, etc.), (vi) a performance parameter of the ad (e.g., selection rate, user rating, conversion rate, etc.), (vii) location targeting information, etc. In addition, the score of an ad may be a function of how the ad performs (e.g., in terms of selection rate, conversion rate, etc.) on devices with call functionality.

Referring back to block 810, if, on the other hand, the request type is from a “limited” client device with call functionality (e.g., a client device with a small display, a slow connection speed, and/or slow processing speed), the right branch of method 800 is performed. For example, one or more local ads with call-on-select code may be served (Block 830) before the method 800 is left (Node 850). As shown, one or more local ads with links to documents (e.g., Web pages) may also be served. (Block 840) As was the case with block 820 of the left branch, the ads may be served in accordance with an ad score. The score of an ad may be a function of one or more of (i) its relevance to a current user interest (e.g., inferred from a search query or document), (ii) relevance to a user type, (iii) relevance to a user, (iv) an offer per impression, (v) an offer per user action (e.g., selection, conversion, etc.), (vi) a performance parameter of the ad (e.g., selection rate, user rating, conversion rate, etc.), (vii) location targeting information, etc. In addition, the score of an ad may be a function of how the ad performs (e.g., in terms of selection rate, conversion rate, etc.) on devices with call functionality and limited displays and/or limited communications connections.

In an alternative embodiment, as long as the user device has call functionality, all types of ads may be considered, but the score of the ads considers the user device type. For example, the user device type may affect a performance parameter of an ad used in determining the ad's score.

In each of the branches of the method 800, local ads are served. This may involve (i) determining where the client device is, (ii) finding ads relevant to the determined location, and (iii) scoring the location-relevant ads. Examples of how these acts may be performed are provided in the following.

Determining where the client device is can be done in a number of ways. For example, if the client device has GPS information (e.g., a GPS enabled telephone), this information may have been provided in the request. Alternatively, or in addition, the user may have provided such information in a search query (e.g., the search query was “plumbers zip=94043” or “plumbers in palo alto”). Alternatively, or in addition, the user may have provided the information (e.g., either in a current session or a previous one) in response to a request for such information.

Determining location relevant ads can be done in a number of ways. For example, location targeting information (e.g., derived from telephone numbers in a Yellow Page listing, derived from an address in a Yellow Page listing, and/or inferred from the coverage area of a Yellow Pages book which contained the listing) of the ad can be matched with client device location information in the query.

Scoring location relevant ads can be done in a number of ways and may be a function of one or more of (i) which advertisers had the biggest ads in the Yellow Pages (e.g., did they pay for a graphic or a box in the Yellow Pages, in which case such ads can be given preference if a payment model proportional to what advertisers pay the Yellow Pages is to be used), (ii) how much the advertiser is paying (or is willing to pay) to have its ad served, (iii) expected selection rate or conversion rate, (iv) expected call-through rate, (v) relevance (e.g., based on keyword or concept targeting, based on location targeting), etc.

In addition, if an ad can be rendered in alternative formats (e.g., text-only, text plus graphics, image, audio, animation, video, etc.), determining which of the alternative formats to use may be determined as a function of one or more of (i) the end user's preference (e.g., provided by the user expressly, inferred from browser option settings, etc.), (ii) characteristics of the client device (e.g., can a cell phone's browser display graphics), (iii) characteristics of the communications connection (e.g., whether the connection fast enough to support graphics).

### § 4.2.5 Exemplary Ad Displays

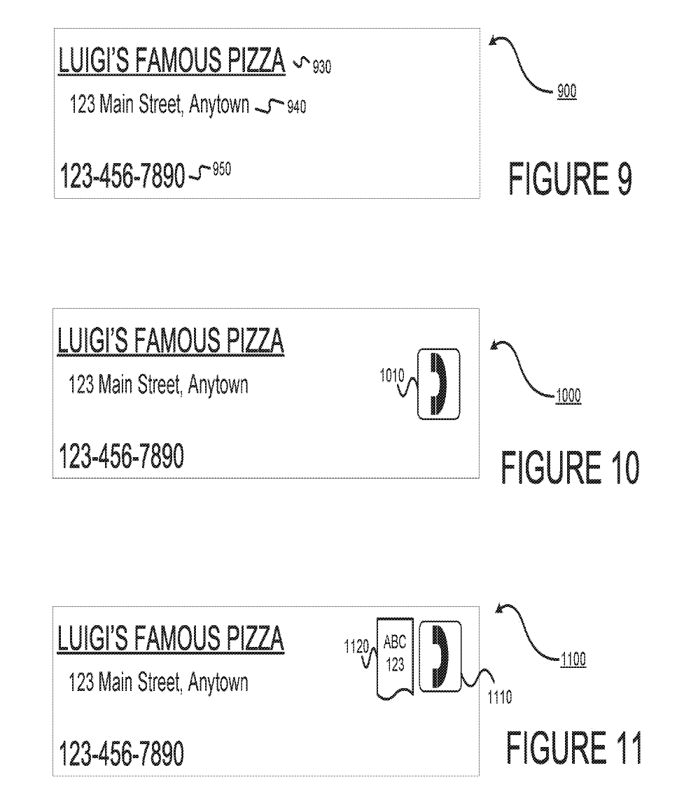

FIGS. 9-13 are exemplary ad displays consistent with the present invention. FIG. 9 is a text ad 900 which may include one or more of an establishment name line 930, an establishment address 940 and an establishment telephone number 950. Other information, such as that described in the '868 application for example, may be used instead of, or in addition to such information. Typically, when such an ad is selected by a user clicking on the ad, an associated Web page is loaded onto the user's browser. However, as discussed above, this may not be desirable for certain user devices. Thus, in at least some embodiments consistent with the present invention, selecting the ad may initiate a telephone call to the establishment.

FIG. 10 is a text ad 1000 which includes call-on-select functionality as indicated by icon button 1010. In some embodiments of the present invention, a call (to a telephone number associated with the ad) is initiated when the icon button 1010 is selected (e.g., via touch screen, stylus, keystroke, pointer, such as a joystick, a touchpad, a track call, etc.). Depending on the embodiment, if a portion of the ad 1000 other than the icon button 1010 is selected, a call can be initiated, or, alternatively, a linked document can be rendered on the browser of the device.

FIG. 11 is a text ad 1100 which includes call-on-select functionality as indicated by icon button 1110, as well as linked document functionality as indicated by icon button 1120. In some embodiments of the present invention, a call (to a telephone number associated with the ad) is initiated when the icon button 1110 is selected and a linked document is rendered on the browser when the icon button 1120 is selected. Depending on the embodiment, if a portion of the ad 1100 other than the icons buttons 1110 and 1120 is selected, a call can be initiated, or, alternatively, a linked document can be rendered on the browser of the device.

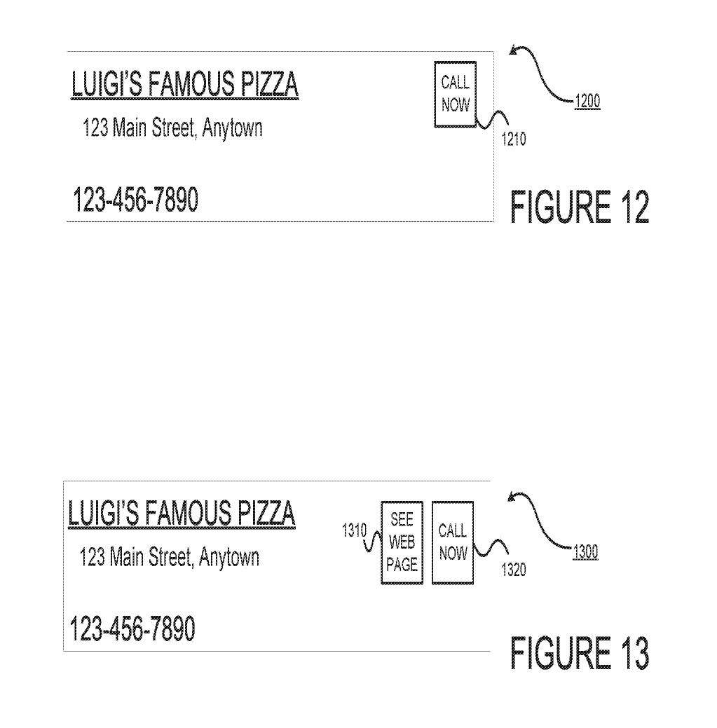

FIG. 12 is a text ad 1200 which includes call-on-select functionality as indicated by button 1210. In some embodiments of the present invention, a call (to a telephone number associated with the ad) is initiated when the button 1210 is selected. Depending on the embodiment, if a portion of the ad 1200 other than the button 1210 is selected, a call can be initiated, or, alternatively, a linked document can be rendered on the browser of the device.

FIG. 13 is a text ad 1300 which includes call-on-select functionality as indicated by button 1310, as well as linked document functionality as indicated by button 1320. In some embodiments of the present invention, a call (to a telephone number associated with the ad) is initiated when the button 1310 is selected and a linked document is rendered on the browser when the button 1320 is selected. Depending on the embodiment, if a portion of the ad 1300 other than the buttons 1310 and 1320 is selected, a call can be initiated, or, alternatively, a linked document can be rendered on the browser of the device.

Before, concurrent with, or after the call initiation, informational messages (e.g., “YOU ARE NOW CALLING ______”) can be rendered on the telephone.

Ads with both call and linked document functionality may have different performance parameters associated with the different functionality. Alternatively, or in addition, the ad may have different offers associated with different user actions (e.g., a first offer for a call and a second offer for a linked document referral). Referring back to method 800, the scoring of ads may consider one or more of the different performance parameters and/or one more of the different offers.

Various alternative functionality of the ads, described above, may be performed depending on one or more of default values of the ad server, advertiser preferences, user or user set preferences, content owner preferences, content owner group preferences, etc.

Although text ads were shown in FIGS. 9-13, other types of ads, such as those listed in § 4.1.1 above, can be used in a manner consistent with the present invention. Further, different ways of navigating to (a) loading a document and/or (b) dialing a telephone number are possible. For example, when a user selects an ad, they may be asked whether they want to visit the advertiser's Web page or talk to the advertiser.

### § 4.2.6 Ad Selection Responsive Actions

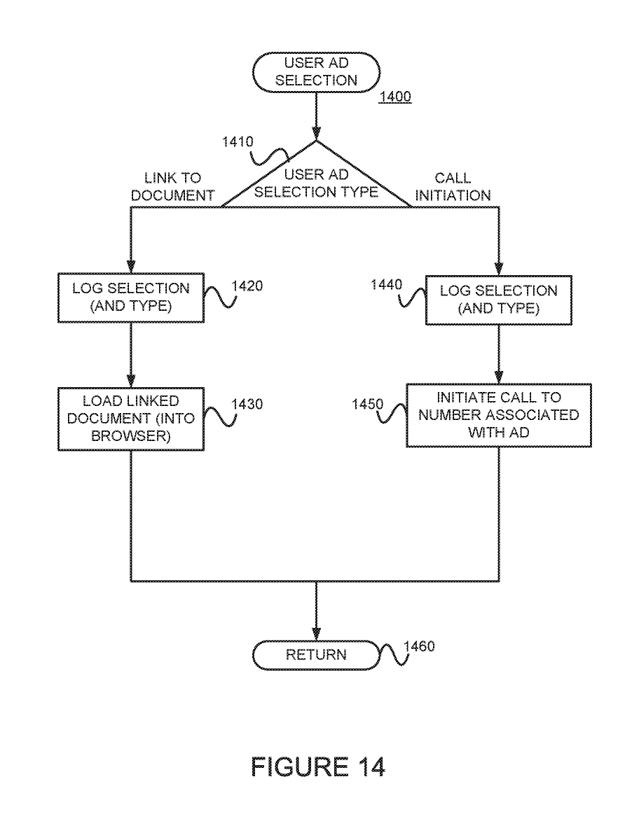

FIG. 14 is a flow diagram of an exemplary method 1400 for performing user ad selection operations in a manner consistent with the present invention. As indicated by block 1410, different branches of the method 1400 may be performed depending on a user ad selection type. (Recall, e.g., ads 1000, 1100, 1200 and 1300 described above.) If the user ad selection type is a link to document, the left branch of the method 1400 is performed, while if the user ad selection type is a call initiation, the right branch of the method 1400 is performed.

If the user ad selection is a link to document, the ad selection (and type) may be logged (Block 1420) and the linked document may be rendered on the user device (e.g., loaded into a browser) (Block 1430), before the method 1400 is left (Node 1460). If, on the hand, the user ad selection is a call initiation, the ad selection (and type) may be logged (Block 1440) and a call to a number associated with the ad may be initiated (Block 1450) before the method 1400 is left (Node 1460). Although not shown, other user actions may be logged (e.g., conversion, user terminating the call before establishment or before a certain point, etc.).

### § 4.2.7 Exemplary Apparatus

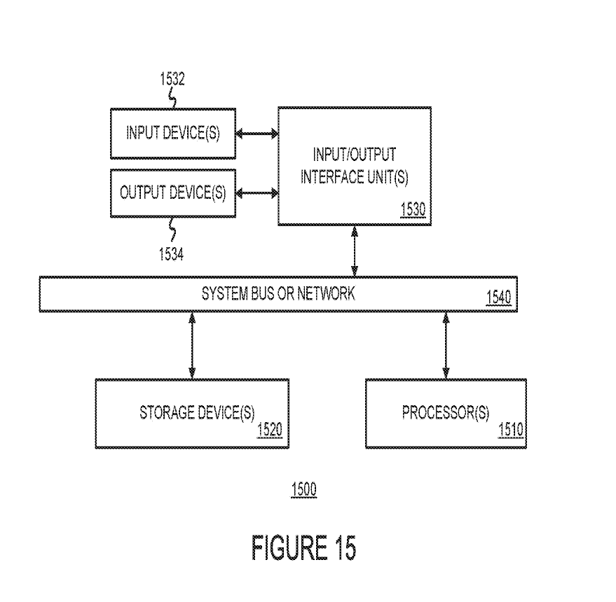

FIG. 15 is a block diagram of a machine 1500 that may perform one or more of the operations discussed above. The machine 1500 includes one or more processors 1510, one or more input/output interface units 1530, one or more storage devices 1520, and one or more system buses and/or networks 1540 for facilitating the communication of information among the coupled elements. One or more input devices 1532 and one or more output devices 1534 may be coupled with the one or more input/output interfaces 1530.

The one or more processors 1510 may execute machine-executable instructions (e.g., C or C++ running on the Solaris operating system available from Sun Microsystems Inc. of Palo Alto, Calif., the Linux operating system widely available from a number of vendors such as Red Hat, Inc. of Durham, N.C., the BREW or J2ME applications platforms, the Symbian operating system from Symbian of London, UK, Java, assembly, Perl, etc.) to effect one or more aspects of the present invention. At least a portion of the machine executable instructions may be stored (temporarily or more permanently) on the one or more storage devices 1520 and/or may be received from an external source via one or more input interface units 1530.

In one embodiment, the machine 1500 may be one or more conventional personal computers, mobile telephones, PDAs, etc. In the case of a conventional personal computer, the processing units 1510 may be one or more microprocessors. The bus 1540 may include a system bus. The storage devices 1520 may include system memory, such as read only memory (ROM) and/or random access memory (RAM). The storage devices 1520 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 1532, such as a keyboard and pointing device (e.g., a mouse) for example. Other input devices such as a keypad, buttons, microphone, a joystick, a game pad, a satellite dish, a scanner, or the like, may also (or alternatively) be included. These and other input devices are often connected to the processing unit(s) 1510 through an appropriate interface 1530 coupled to the system bus 1540. The output devices 1534 may include a monitor or other type of display device, which may also be connected to the system bus 1540 via an appropriate interface. In addition to (or instead of) the monitor, the personal computer may include other (peripheral) output devices (not shown), such as speakers and printers for example.

The machine 1500 may be a mobile telephone such as those 500 and 600 illustrated in FIGS. 5 and 6, respectively.

Referring back to FIG. 2, one or more machines 1500 may be used as ad server 210, search engine 220, content server 230, e-mail server 240, and/or user device 250.

### § 4.2.8 Alternatives and Extensions

The ad server may be compensated in a number of different ways. As one example, a Yellow Pages publisher may enter into a fee sharing arrangement with the ad server. (The Yellow Page Publisher should be able to charge a premium or surcharge for such an additional service.) Alternatively, the ad server may contact the local establishment directly and try to enter into an agreement (e.g., getting a flat fee, a bid or maximum offer per impression, selection, conversion, etc.).

In at least some embodiments consistent with the present invention, call-on-select ads are only served and/or have selection enabled if the telephone number is a local telephone number. Such embodiments would avoid long distance calls. This feature may be linked with a calling plan of the user device.

Not all ad links need to have telephone numbers associated with them. In at least some embodiments consistent with the present invention, the user is given an option (either before or after ad selection) of making a voice call or going to the Web page. As shown in FIGS. 11 and 13 above, separate buttons with separate links for Web page display or voice calls can be provided. Alternatively, the advertiser can decide this. As yet another alternative, whether to display a Web page or make a voice call may be determined by pre-existing user preferences.

To avoid user confusion, at least some embodiments consistent with the present invention may enforce the use of a consistent user interface across all ads. The advertisers may be forced to have their ads conform to such a consistent format when entering ads into the ad system, or a format conversion from a non-compliant format to the consistent format may occur later.

Advertisers can chose to offer different amounts for document (e.g., Web page) load-on-selection and call-on-selection. Performance parameters for each can be tracked separately.

The telephone number can be included as data and sent in variety of forms. It does not even need to be interpreted by standard HTML browsers. It can be sent as meta data in the header of the page returned. Alternatively, or in addition, it can be sent as comments with the each advertisement. Alternatively, or in addition, it can be sent as structured data. Alternatively, or in addition, it can be sent as a “tel:XXX” tag. The first and second options are useful in cases in which the renderer is not known or under control of the ad server (for example if it is shown in a browser that does not support tel links). In such cases, the telephone call functionality may not exist and the phone number will simply be ignored. The third option is useful if a structured feed is returned to the user device. For example, search results may be returned to a mobile telephone in an XML formatted feed. Advertisements and all the related advertisement fields can also be formatted in XML (or any other structured language). The XML is treated as a data feed and the rendering is all dictated by the intelligence built into a client application on the user device.

In at least some embodiments consistent with the present invention, the call-on-select telephone number may connect the client to an audio document (e.g., a voice message) or a live operator, depending on the telephone number specified by the advertiser. Although not shown in FIGS. 9-13, different buttons can be used to indicate whether the call will be placed to an audio document or a live operator.

In at least some embodiments consistent with the invention, selecting an ad or a button on an ad may initiate both a call and a document-load. The call initiation and document-load initiation may occur in parallel or in series. In still another alternative embodiment consistent with the present invention, a limited document (e.g., in terms of time to load and render) with one or more call-on-select links can be loaded in response to an ad selection. For example, rather than load a large Web page, a limited document stating:

### CLICK HERE TO PLACE A TAKE OUT ORDER

### CLICK HERE TO ORDER DELIVERY

### CLICK HERE TO MAKE A RESERVATION

may be loaded.

Although some of the exemplary embodiments described the use of a browser, at least some embodiments consistent with the present invention may use some other content rendering application or device.

Instead of, or in addition call-on-select functionality, and/or a link to an advertiser's Webpage, a link to a more detailed ad (e.g., a “full ad”) of the advertiser can be provided. For example, if the original ad is a text only ad and only includes a business name, address and telephone number, such an ad may include an executable link to a corresponding ad with graphical elements, descriptive text, hours of operation, etc.

Although many of the exemplary embodiments were described in terms of online ads, embodiments consistent with the present invention may be used with other ads, such as electronically storable (text, image, audio, animation, video, etc.) ads for example.

### § 4.3 Examples of Operations

The following examples illustrate the utility of an exemplary embodiment of the present invention. In a first example, assume that there are five location-relevant ads with at least the following information:

AD 1: landing page: www.fareasttaste.com
offer-per-selection_{doc}: $0.10
selection rate_{doc}: 0.05
call-on-select number: NONE
offer-per-selection_{call}: NONE
selection rate_{call}: NONE
AD 2: landing page: www.siamgarden.com
offer-per-selection_{doc}: $0.05
selection rate_{doc}: 0.05
call-on-select number: 1-234-567-8910
offer-per-selection_{call}: $0.25
selection rate_{call}: 0.15
AD 3: landing page: www.noodles.com
offer-per-selection_{doc}: $0.50
selection rate_{doc}: 0.12
call-on-select number: 1-234-109-8765
offer-per-selection_{call}: $0.30
selection rate_{call}: 0.20
AD 4: landing page: NONE
offer-per-selection_{doc}: NONE
selection rate_{doc}: NONE
call-on-select number: 1-234-789-1011
offer-per-selection_{call}: $0.50
selection rate_{call}: 0.13
AD 5: landing page: NONE
offer-per-selection_{doc}: NONE
selection rate_{doc}: NONE
call-on-select number: 1-234-111-2222
offer-per-selection_{call}: $0.05
selection rate_{call}: 0.05

Assume further that an ad score is the product of offer per selection and selection rate. Finally, assume that if the user device requesting the ad has a limited display, that the score_{doc} is reduced by a factor of 20 (based on an assumption that the selection rate for selecting an ad with a linked document is much less on a device with a limited display than on a device with a normal display).

Assume now that local ads AD 1 through AD 5 are eligible for a first request from a personal computer (normal display assumed) without call functionality. The local ads may be scored and ranked as shown in TABLE I.

TABLE I

| | | SELECTION | | |
|---|---|---|---|---|
| AD | OFFER_{DOC} | RATE_{DOC} | SCORE | RANK |
| AD 1 | $0.10 | 0.05 | 0.0050 | 2 |
| AD 2 | $0.05 | 0.05 | 0.0025 | 3 |
| AD 3 | $0.50 | 0.12 | 0.0600 | 1 |
| AD 4 | NONE | NONE | NONE | |
| AD 5 | NONE | NONE | NONE | |

Notice that since AD 4 and AD 5 don't have linked documents and since the requesting user device doesn't have call functionality, otherwise eligible ads aren't scored (or are given a default score of 0.0000 for example). In some embodiments, such ads aren't served to avoid user confusion and frustration and so that a user's attention isn't taken away from AD 1 through AD 3.

Assume now that local ads AD 1 through AD 5 are eligible for a second request from a mobile telephone (limited display) with support for call-on-select functionality. The local ads may be scored and ranked as shown in TABLE II.

TABLE II

| | | SELECTION | | | SELECTION | |
|---|---|---|---|---|---|---|
| AD | OFFER_{DOC} | RATE_{DOC} | SCORE_{DOC} | OFFER_{CALL} | RATE_{CALL} | SCORE_{CALL} |
| AD 1 | $0.10 | 0.05 | 0.000250 | NONE | NONE | NONE |
| AD 2 | $0.05 | 0.05 | 0.000125 | $0.25 | 0.15 | 0.0375 |
| AD 3 | $0.50 | 0.12 | 0.003000 | $0.30 | 0.20 | 0.0600 |
| AD 4 | NONE | NONE | NONE | $0.50 | 0.13 | 0.0650 |
| AD 5 | NONE | NONE | NONE | $0.05 | 0.05 | 0.0025 |

An overall score may be a function of one or both of the score_{doc} and score all. For example, an overall score may be MAX{score_{doc}, score_{call}}. Alternatively, an overall score may be score_{doc}+score_{call}. Assume, for this example, that the overall score is the maximum of the score_{doc} and score_{call}. The rank of the local ads, from highest to lowest, would be AD 4, AD 3, AD 2, AD 5. Notice that even if AD 3 didn't have a call-on-select offer and functionality, its document score would still have been better than the call score of AD 5.

Finally, assume now that local ads AD 1 through AD 5 are eligible for a third request from a laptop computer (normal display assumed) with support for call-on-select functionality. The local ads may be scored and ranked as shown in TABLE III.

TABLE III

| | | SELECTION | | | SELECTION | |
|---|---|---|---|---|---|---|
| AD | OFFER_{DOC} | RATE_{DOC} | SCORE_{DOC} | OFFER_{CALL} | RATE_{CALL} | SCORE_{CALL} |
| AD 1 | $0.10 | 0.05 | 0.0050 | NONE | NONE | NONE |
| AD 2 | $0.05 | 0.05 | 0.0025 | $0.25 | 0.15 | 0.0375 |
| AD 3 | $0.50 | 0.12 | 0.0120 | $0.30 | 0.20 | 0.0600 |
| AD 4 | NONE | NONE | NONE | $0.50 | 0.13 | 0.0650 |
| AD 5 | NONE | NONE | NONE | $0.05 | 0.05 | 0.0025 |

Notice that in this case, since the user device has a full display, the document scores are not reduced. The final ranking may depend on how the overall score is determined using one or both of the score_{doc} and score all. For example, these scores may be combined in a un-weighted or weighted manner (e.g., as specified by the advertiser, as specified by the ad serving system, and/or accounting for user behavior with respect to call-on-select and document-load-on-select ads).

In addition to location being used for determining relevance, location targeting information of the ads and location information from the request may be used when scoring ads.

### § 4.4 Conclusions

As can be appreciated from the foregoing, the present invention permits local establishments to quickly and effectively advertise on line. These types of ads are especially valuable for queries performed on mobile phones, which will most likely be the type for which an immediate (and many times local) response is required (e.g., where to eat dinner, where to order a pizza, where is the nearest service station, which plumber to call, etc.). The present invention may also permit an ad server to better monetize searches and document requests, such as those on devices like mobile telephones that support call-on-select functionality, while permitting the avoidance of poor user experiences on such devices such as those due to small displays on such devices, slow communications connections and/or processors on such devices, and/or limits of user input on such devices. Further, in the same way that cost-per-selection yields higher offers and revenues than cost-per-impression, cost-per-call may yield higher offers and revenues than cost-per-selection (with an ad landing Web page being loaded upon selection) since the local establishment can talk directly with a potential customer.

What is claimed is:

1. A system of font or format-based heuristic extraction of data structures within an online computer network environment, comprising:
a content serving system comprising an interface to transmit and receive data via the online computer network and one or more processors to:
access a data structure storing entity data comprising a set of information for each of a plurality of establishments;
parse, with a heuristic technique comprising at least one of a font-based policy or a format-based policy, the set of information for each of the plurality of establishments of the entity data stored in the data structure to extract name data, location data, and type data;
determine, for each of the plurality of establishments, content selection criteria using the name data, the location data, and the type data extracted from the set of information for each of the plurality of establishments of the entity data stored in the data structure;
generate, for each of the plurality of establishments, an online content item with the content selection criteria determined based on the name data, the location data, and the type data extracted from the set of information for each of the plurality of establishments of the entity data stored in the data structure;
determine a location of a computing device provided by a global positioning component of the computing device based on information received from the computing device via the online computer network environment;
select, responsive to the location of the computing device and based on the content selection criteria, the online content item corresponding to an establishment of the plurality of establishments; and
provide, via the online computer network to the computing device, the online content item selected responsive to the location of the computing device and based on the content selection criteria to cause the computing device to render the online content item on a display device of the computing device.

2. The system of claim 1, wherein the location of the computing device comprises:
a latitude and a longitude of the computing device;
a position of the computing device derived from a global positioning satellite;
an area code of a telephone number of the computing device; and
information derived from an access point with which the computing device is registered.

3. The system of claim 1, wherein the content serving system is further configured to:
provide, to the establishment associated with the online content item provided for display on the computing device, an indication of at least one of an impression of the online content item, a selection of the online content item, or a conversion of the online content item.

4. The system of claim 1, wherein the content serving system is further configured to:
indicate, to the establishment associated with the online content item provided for display on the computing device, a number of impressions received for the online content item over a time period.

5. The system of claim 1, wherein the content serving system is further configured to:
receive a data feed including information about listings of an online directory; and
process the data feed to extract the set of information for each of the plurality of establishments.

6. The system of claim 5, wherein the content serving system is further configured to:
provide, to a publisher of the listings of the directory, an indication of an impression of the online content item, a selection of the online content item, or a conversion of the online content item.

7. The system of claim 5, wherein the content serving system is further configured to:
provide, to a publisher of the listings of the directory, an indication of a number of impressions of the online content item, a number of selections of the online content item, or a number of conversions of the online content item over a time period.

8. The system of claim 1, wherein the content serving system is further configured to:
scan listings of the entity to generate scans; and
process the scans to extract at least one of the name data, the location data, or the type data.

9. The system of claim 8, wherein the content serving system is further configured to:
process the scans to extract at least one of an address of the establishment or a telephone number of the establishment.

10. The system of claim 1, wherein the content serving system is further configured to:
use a zip code of an address of each of the plurality of establishments to determine the location data for each of the plurality of establishments.

11. The system of claim 1, wherein the content serving system is further configured to:
use an area code of a telephone number of each of the plurality of establishments to determine the location data of each of the plurality of establishments

12. The system of claim 1, wherein the content serving system is further configured to:
generate the online content item with call on select functionality.

13. The system of claim 1, wherein the content serving system is further configured to:
generate the online content item with a selectable link to a webpage corresponding to the establishment.

14. The system of claim 1, wherein the content serving system is further configured to:
determine the content selection criteria using entity-type subject headings extracted from the entity data.

15. The apparatus of claim 1, wherein content selection criteria includes keywords related to the location data of the establishment.

16. A method of font or format-based heuristic extraction of data structures via an online computer network environment, comprising:
accessing, by an interface of a content serving system comprising one or more processors, a data structure storing entity data comprising a set of information for each of a plurality of establishments;
parsing, by the content serving system, using a heuristic technique comprising at least one of a font-based policy or a format-based policy, the set of information for each of the plurality of establishments of the entity data stored in the data structure to extract name data, location data, and type data;
determining, by the content serving system, for each of the plurality of establishments, content selection criteria using the name data, the location data, and the type data extracted from the set of information for each of the plurality of establishments of the entity data stored in the data structure;
generating, by the content serving system, for each of the plurality of establishments, an online content item with the content selection criteria determined using the name data, the location data, and the type data extracted from the set of information for each of the plurality of establishments of the entity data stored in the data structure;
receiving, by the content serving system, from a computing device via the online computer network environment, a location of the computing device provided by a global positioning component of the computing device;
selecting, by the content serving system, responsive to the location received from the computing device and based on the content selection criteria, the online content item corresponding to an establishment of the plurality of establishments; and
providing, by the content serving system, via the online computer network to the computing device, the online content item selected responsive to the location of the computing device and based on the content selection criteria to cause the computing device to render the online content item on a display device of the computing device.

17. The method of claim 16, wherein the location of the computing device comprises:
a latitude and a longitude of the computing device;
a position of the computing device derived from a global positioning satellite;
an area code of a telephone number of the computing device; and
information derived from an access point with which the computing device is registered.

18. The method of claim 16, comprising
providing, by the content serving system, to the establishment associated with the online content item provided for display on the computing device, an indication of at least one of an impression of the online content item, a selection of the online content item, or a conversion of the online content item.

19. The method of claim 16, comprising
indicating, by the content serving system, to the establishment associated with the online content item provided for display on the computing device, a number of impressions received by the online content item during a time period.

20. The method of claim 16, comprising:
receiving, by the content serving system, a data feed including information about listings of an online directory; and
processing, by the content serving system, the data feed to extract the set of information for each of the plurality of establishments.
